(19) United States
(12) Patent Application Publication
(10) Pub. No.: US 2011/0251042 A1
(43) Pub. Date: Oct. 13, 2011

(54) ALUMINA SINTERED BODY

(75) Inventors: Hiroshi Araki, Obu-shi (JP); Hirofumi Suzuki, Kuwana-shi (JP); Itsuhei Ogata, Okazaki-shi (JP)

(73) Assignees: NIPPON SOKEN, INC., Nishio-city (JP); DENSO CORPORATION, Kariya-city (JP)

(21) Appl. No.: 13/082,500

(22) Filed: Apr. 8, 2011

(30) Foreign Application Priority Data
Apr. 8, 2010 (JP) 2010-089310

(51) Int. Cl. C03C 14/00

(52) U.S. Cl. 501/32

(57) ABSTRACT

An alumina sintered body of the present invention has alumina crystals as a main phase and an amorphous grain boundary glass phase. The amorphous grain boundary glass phase is a grain-boundary glass phase having an amorphous glass component in which at least one of either CaO or MgO is added to SiO₂, and at least one type of oxide selected from rare-earth elements and elements in Group IV of the periodic table included in the amorphous glass component as a specific component. When a composition ratio of the main phase and the amorphous grain boundary glass phase is alumina:amorphous glass component:specific component=a:b:c (a+b+c=100% by weight), in a triangular coordinate of which peaks are alumina, the amorphous glass component, and the specific component, a point (a,b,c) is within a range surrounded by four points, A(98.0,1.0,1.0), B(90.0,5.0,5.0), C(93.5,5.0,1.5), and D(97.8,2.0,0.2).

### CROSS REFERENCES TO RELATED APPLICATIONS

The present application relates to and incorporates by reference Japanese Patent application No. 2010-089310 filed on Apr. 8, 2010.

### BACKGROUND CF THE INVENTION

1. Field of the Invention

The present invention relates to an alumina sintered body containing alumina as a main component. In particular, the present invention relates to an alumina sintered body having improved low-temperature sinterability and voltage endurance that can be used in insulators in spark plugs for internal combustion engines, substrates for electronic components, insulating protective elements, and the like.

2. Description of the Related Art

The alumina sintered body is widely used as insulation material for spark plugs in automobile engines, and various substrates and elements, because the alumina sintered body contains alumina (Al₂O₃) having a physically stable property as a main component, and has excellent insulation and voltage endurance characteristics. Alumina has a high melting point (about 2050° C.). Therefore, if the alumina content is increased within the alumina sintered body, voltage endurance can be expected to be higher. However, when the alumina content is increased, sinterability decreases. By a sintering aid being added, sintering is made possible at a temperature such as 1650° C. or below. In general, silica (SiO₂), magnesia (MgO), calcia (CaO), and the like have been used as the sintering aid. Those sintering aid are capable of forming a low-melting-point lipoid phase by eutectic reaction with alumina.

On the other hand, as automobile engines become increasingly high-output and smaller in size, and as space occupied by a valve increases within the combustion chamber, demand is rising for smaller spark plugs. In accompaniment, the thickness of the insulator is becoming thinner in the spark plugs. Higher voltage endurance is demanded for the alumina sintered body used as the insulation material. However, in the conventional alumina sintered body including the SiO₂—MgO—CaO sintering aid, the energy band gap of the low-melting-point amorphous glass phase formed within the grain boundaries of alumina is small, and insulation breakdown easily occurs. Therefore, there was a limit to increasing in voltage endurance of the alumina sintering body.

Increasing voltage endurance of the crystal grain boundary phase has been discussed, JP-A-S63-190753 discloses that at least one of yttria, magnesia, zirconia, and lanthanum oxide is used as a new sintering aid, in place of the SiO₂—MgO—CaO sintering aid. As a result of alumina having a particle size of 1 μm or less being combined with the sintering aid, the grain boundary component of the alumina crystal becomes crystallized, and a high-melting-point grain boundary phase is formed. As a result of abnormal grain growth of alumina being suppressed, conduction path is lengthened. At last alumina ceramic having a voltage endurance of 30 to 35 kV/mm is achieved.

An alumina, insulating material of which the cross-sectional area of alumina-based main phase particles having a particle size of 20 μm or greater is 500 or more, is disclosed in JP-A-H11-317279. The insulating material is achieved by having a high alumina content of 95% to 99.7% by weight, and containing an additional-element material selected from Si, Ca, Mg, Ba, and B as a sintering aid, such that the total content thereof is 0.3% to 5% by weight. As a result of the alumina-based main phase particles being suitably coarsened, the amount of grain boundaries that tend to become paths for breakdown can be reduced, and an alumina insulating material can be achieved having high voltage endurance.

JP-A-2009-127263 discloses an alumina compound sintered compact that includes alumina, mullite, zircon, zirconia, and a specific metal oxide. The alumina compound sintered compact is achieved using an alumina raw material, a zircon raw material, and a raw material of the specific metal oxide selected from Mg, Ca, Sr, Ba, and Group III elements excluding actinoid.

Because the alumina ceramic uses fine alumina as a raw material in JP-A-S63-190753, porosity within the sintered body tends to be high. Moreover, the alumina content has an upper limit, and improvement in voltage endurance becomes limited. Furthermore, the firing temperature becomes high to crystallize the grain boundary component, and firing at a temperature of 1600° C. to 1650° C. is required to achieve a sintered density of 95% or more.

The alumina insulating material in JP-L-H11-317279 uses alumina with an average particle size of 1 μm or less, and the alumina is grown to large particles having a particle size of 20 μm or more. The volume fraction of alumina-based main phase particles is increased, and the amount of grain boundaries that easily become a starting point for breakdowns is reduced. However, when the rate of particle growth is insufficiently suppressed, pores remain within, the large particles that have been grown, and voltage endurance may decrease. Furthermore, raw material costs and manufacturing costs increase, because the firing temperature in the example is a high temperature of 1600° C.

In the alumina compound sintered compact in JP-A-2008-127263, the specific metal oxide is uniformly dispersed in the mullite generated by reaction between alumina and zircon, and the grain boundary phase between adjacent alumina crystal grains is crystallized. However, it is not easy to crystallize mullite, zircon, zirconia, and the specific metal oxide in the grain boundary, and to disperse the crystal grains without forming separately agglomerated, crystals. Although the firing temperature is 1300° C. to 1600° C., firing at a comparatively low temperature is considered difficult because the crystal phase is formed in the grain boundaries.

### SUMMARY OF THE INVENTION

As described above, it has been discussed to improve voltage endurance by crystallization of the grain boundary in the past. However, crystallizing the grain boundary required firing at high temperature and for many hours. Therefore, an object of the present invention is to actualize an alumina sintered body capable of being sintered at a lower firing temperature and reducing costs related to the firing procedure, and having excellent voltage endurance characteristics.

According to one aspect of the present invention, there is provided an alumina sintered body comprising alumina crystals as a main phase and an amorphous grain boundary phase formed in crystal grain boundaries of the alumina crystals. The amorphous grain boundary phase is an amorphous grain boundary glass phase having an amorphous glass component in which at least one of either CaO or MgO is added to SiO₂ and at least one type of oxide selected from rare-earth elements and elements in Group IV of the periodic table included in the amorphous glass component as a specific component. When a composition ratio of the main phase and the amorphous grain boundary glass phase is alumina:amorphous glass component:specific component=a:b:c (a+b+c=100% by weight), in a triangular coordinate of which peaks are alumina, the amorphous glass component, and the specific component, a point (a,b,c) is within a range surrounded by four points, A(98.0,1.0,1.0), B(90.0,5.0,5.0), C(93.5,5.0,1.5), and D(97.8,2.0,0.2).

The inventors and the like of the present invention have examined relation between the components of the SiO₂—CaO—MgO-based amorphous grain boundary glass phase and voltage endurance. They have found that electrons are supplied to SiO₂ as a result of CaO or MgO being added, and the energy band gap becomes smaller, thereby causing the high-voltage endurance characteristics of SiO₂ to deteriorate. On the contrary, when a specific element is mixed in the grain boundary phase, the electrons from CaO or MgO are absorbed, and the energy band gap can be increased. Moreover, as a result of CaO, MgO, and the specific component being added, the melting point of the amorphous grain boundary glass phase becomes lower, thereby making it possible to be sintered at a lower firing temperature Because grain growth is suppressed, the conduction path formed in the amorphous grain boundary glass phase surrounding the alumina crystals lengthens, and insulation breakdown does not easily occur. The present invention is based on these findings.

In fact, the alumina sintered body of the present invention has a SiO—CaO—MgO low-melting-point amorphous glass phase in the grain boundary phase of the crystal grain boundaries of the alumina crystals. Therefore, alumina can be sintered at a temperature such as 1450° C. to 1500° C. that is lower than that in the past. In the low-melting-point amorphous glass phase, as a result of the specific component being added to SiO₂—CaO—MgO and composition range being controlled, crystallization of the amorphous grain boundary glass phase can be suppressed. The low-melting-point glass phase is melted at 1400° C., sintering of alumina is promoted, and a compact sintered body having a small particle size is generated. As a result, voltage endurance improves. In addition, as a result of the specific component mixed in the SiO₂—CaO—MgO amorphous glass phase, the energy band gap of the amorphous grain boundary glass phase increases, and movement of electrons is suppressed, leading to further increased voltage endurance. Therefore, a high-quality alumina sintered body that is low cost and has excellent voltage endurance can be actualized.

According to another aspect of the present invention, there is provided an aluminum sintered body has a firing temperature of 1500° C. or below. The amorphous grain boundary phase does not include a crystalline component that is a crystallization of the amorphous glass component or the specific component, or a crystalline component generated from reaction between the amorphous glass component, the specific component, and alumina.

As a result of the firing temperature being set to 1500° C. or less, precipitation of crystals can be suppressed in the amorphous grain boundary glass phase of the alumina sintered body. After sintering, insulation characteristics of the grain-boundary phase deteriorate if the specified component crystallizes. However, because the amorphous grain boundary phase does not include crystalline components, the effects of the present invention can be achieved with certainty, through the effect of low-temperature sintering and the effect of improved voltage endurance by the low-melting-point amorphous glass phase.

According to a further aspect of the present invention, there is provided an aluminum sintered body, when a composition ratio of the amorphous glass component in the amorphous grain boundary glass phase is SiO₂:CaO:MgO=a′:b′:c′ (a′+b′+c′=100% by weight), in a triangular coordinate of which peaks are SiO₂, CaO, and MgO, a point (a′,b′,c′) is within a range surrounded by four points, A′(100,0,0), B′(75,25,0), C′(75,20,5), and D′(95,0,5) (however, A′ is excluded).

The amorphous glass component of the amorphous grain boundary glass phase can have a composition by using a specific composition ratio, it makes possible to prevent precipitation of crystals. Therefore, a uniform, amorphous grain boundary phase can be formed in combination with the specific component, and the effects of the present invention can be further improved.

According to a further aspect of the present invention, there is provided an aluminum sintered body, the amorphous grain boundary glass phase has an energy band gap (ΔeV) of 3.5 eV or more.

The energy band gap of the amorphous grain boundary glass phase is sufficiently higher than that of the SiO₂—CaO—MgO amorphous glass phase. Therefore, an alumina sintered body having high voltage endurance can be actualized.

According to a still further aspect of the present invention, there is provided an aluminum sintered body, the rare-earth elements include Y, Sc, and lanthanoid element, and the elements in Group IV of the periodic table include Hf, Zr, and Ti.

The energy band gap of the amorphous grain boundary glass phase is increased to a desired value or more through use of specific rare-earth elements or elements in Group IV of the periodic table. Therefore, an alumina sintered body having high voltage endurance can be actualized.

According to a still further aspect of the present invention, there is provided an aluminum sintered body, the specific component is at least one type selected from Y₂O₃, HfO₂, ZrO₂, Sc₂O₃, and TiO₂.

specifically, the above-described effects are achieved by the specific component being selected from Y₂O₃, HfO₂, ZrO₂, Sc₂O₃, and TiO₂.

According to a still further aspect of the present invention, there is provided an aluminum sintered body, voltage endurance is greater than 30 kV/mm.

Because the resultant alumina sintered body has high voltage endurance characteristics exceeding 30 kV/mm, the alumina sintered body can be suitably used in various insulation materials, such as an insulator in a spark plug.

### BRIEF DESCRIPTION OF THE DRAWINGS

The invention will be more particularly described with reference to the accompanying drawings in which:

FIG. 1A is a flowchart of an overview of the manufacturing procedures for an alumina sintered body according to a first embodiment of the present invention;

FIG. 1B is an energy level diagram for explaining the operation effects of a specific component of the present invention;

FIG. 2A is a triangular coordinate chart of which the peaks are alumina, amorphous glass component, and specific component, when alumina:amorphous glass component:specific component=a:b:c (a+b+c=100% by weight),

FIG. 2B is a triangular coordinate chart of which the peaks are SiO₂, CaO, and MgO, when SiO₂:CaO:MgO=a′:b′:c′ (a′+b′+c′=100% by weight);

FIG. 3A is a diagram of transmission electron microscopy (TEM) images of sample 6 (firing temperature of 1450° C.) showing a sintered state of an alumina sintered body manufactured in the example 1 of the present invention;

FIG. 3B is a diagram of transmission electron microscopy (TEM) images of sample 8 (firing temperature of 1450° C.) showing a sintered state of an alumina sintered body manufactured in an example 1 of the present invention;

FIG. 4A is a diagram for explaining a method of forming an amorphous glass structure model used to calculate energy band gap (ΔeV);

FIG. 4B is a diagram for explaining a method of calculating an electronic state and calculating the energy band gap (ΔeV);

FIG. 5A is a schematic diagram of a SiO₂ amorphous glass structure;

FIG. 5B and FIG. 5C are schematic diagrams for explaining the effects of the specific component in an amorphous grain boundary glass phase; and

FIG. 6 is a triangular coordinate chart of sample compositions of an alumina sintered body manufactured in an example 2 of the present invention.

### DETAILED DESCRIPTION OF THE PREFERRED EMBODIMENTS

The present invention will hereinafter be described in detail with reference to the drawings.

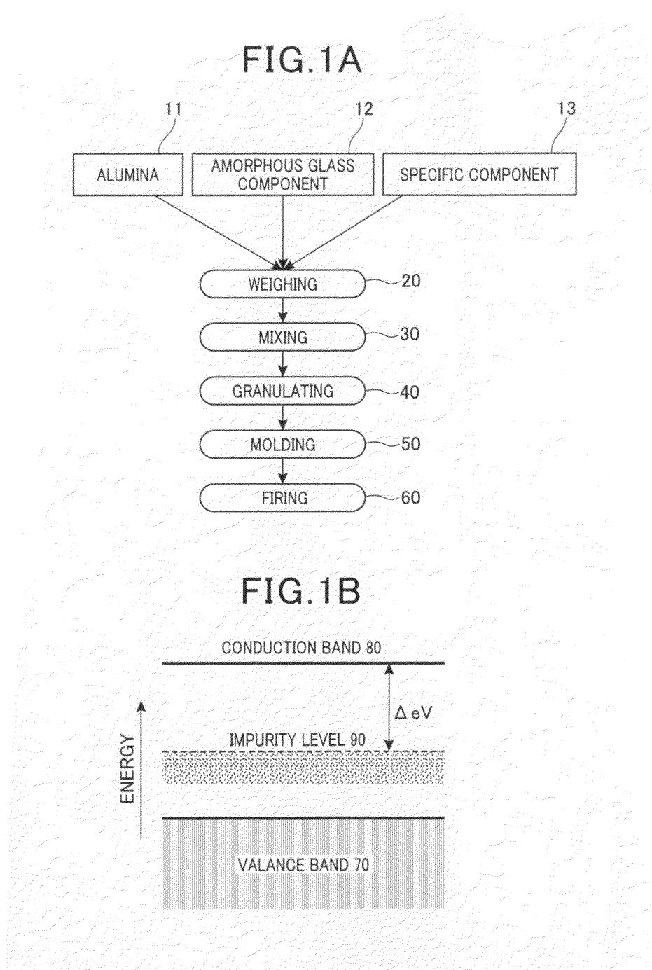

FIG. 1A is a flowchart of an overview of the manufacturing procedures of an alumina sintered body according to a first embodiment of the present invention.

As shown in FIG. 1A, the alumina sintered body of the present invention is formed using alumina 10, an amorphous glass component 11, and a specific component 13 as raw materials. As a result of these components being combined, an alumina sintered body is formed in which alumina crystals are a main phase, and an amorphous grain boundary phase is formed in the crystal grain boundaries of alumina crystals.

The amorphous grain boundary phase includes an amorphous glass component in which, at least one of calcia (CaO) and magnesia (MgO) is added to silica (SiO₂), and a specific component added to the amorphous glass component.

The specific component is at least one type of oxide selected from rare-earth elements and elements from Group IV of the periodic table. The specific component is mixed in the amorphous glass component, and a uniform amorphous grain boundary glass phase is formed. Specifically, examples of the rare-earth elements serving as the specific component are Y, Sc, and lanthanoids. Examples of the elements from Group IV of the periodic table include Hf, Zr, and Ti. The specific component is an oxide of these elements, and is preferably at least one type of oxide selected from Y₂O₃, HfO₂, ZrO₂, Sc₂O₃, and TiO₂.

To achieve the desired voltage endurance characteristics, it is important to determine the composition ratio of the alumina that is the main phase, and the amorphous glass component and the specific component forming the amorphous grain boundary glass phase.

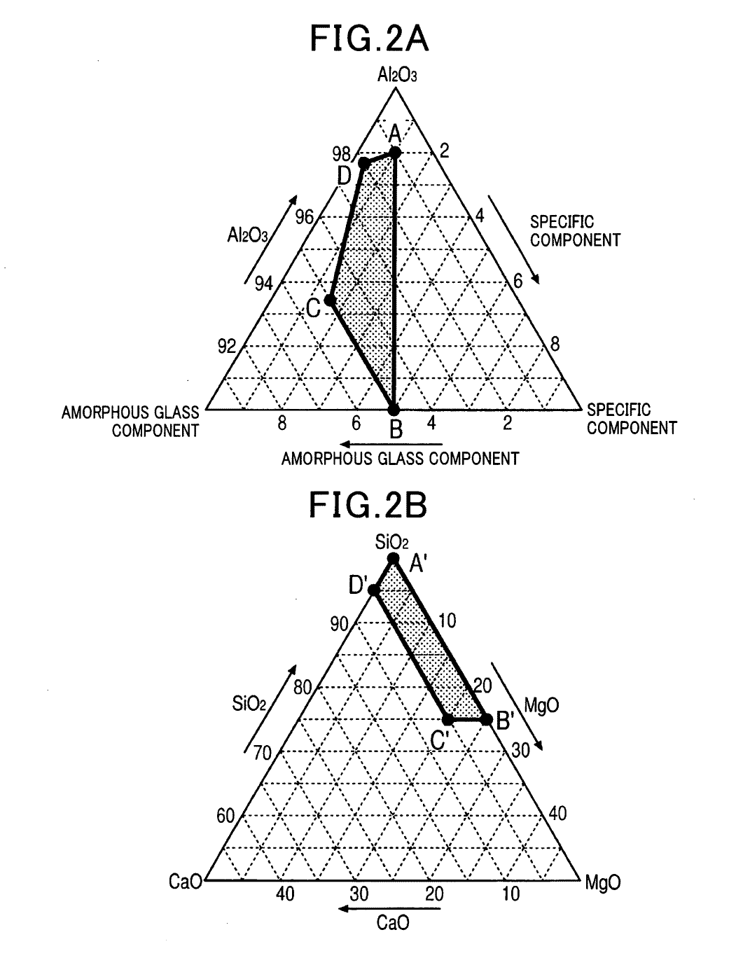

FIG. 2A is a triangular coordinate chart of which the peaks alumina, the amorphous glass component, and the specific component, when alumina:amorphous glass component:specific component=a:b:c (a+b+c=100% by weight). In the triangular coordinates, the composition ratio of each component of the alumina sintered body of the present invention is set such that a point (a,b,c) is within a range surrounded by A(98.0,1.0,1.0), B(90.0,5.0,5.0), C(93.5,5.0,1.5), and D(97.8,2.0,0.2). Here, the triangular coordinates in FIG. 2A show a range in which alumina is 90% to 100% by weight, the amorphous glass component is 0% to 5% by weight, and the specific component is 0% to 5% by weight.

As shown in FIG. 2A, the composition ratio of the amorphous glass component and the specific component serving as a sintering aid to alumina that is the main phase is small, and, combined, does not exceed 10% by weight even at the most. When the amount of sintering aid component is large, although a liquid phase by low-melting point amorphous glass is formed surrounding the main phase and liquid phase sintering of alumina is facilitated, the ratio of alumina decreases and the ratio of the amorphous grain boundary glass phase that becomes a starting point for insulation breakdown increases. As a result, voltage endurance tends to decrease. To achieve an effect of promoting sinterability of the alumina sintered body, the amorphous glass component and the specific component serving as the sintering aid in total is preferably or more by weight. The specific component added to the amorphous glass component increases an energy gap of the amorphous grain boundary glass phase and contributes to voltage endurance characteristics. The amorphous grain boundary glass phase has a low melting point of 1400° C., and as a result of sintering at a low temperature, grain growth in alumina is suppressed, and voltage endurance characteristics are enhanced.

In particular, precipitation of crystal components does not occur and a uniform amorphous grain boundary glass phase can be generated, only when the composition ratio of alumina, the amorphous glass component, and the specific component is within the specified range shown in FIG. 2A. A compact alumina sintered body can be achieved at a firing temperature of 1500° C. or below, and preferably from 1450° C. to 1500° C. The mixing ratio of the specific component to the amorphous glass component is preferably 1:1 or lower, when the amount of the specific component is greater than line AB in FIG. 2A, as a result of excessive addition, crystallization of the specific component easily occurs. In addition, when the added amount of the amorphous glass component is greater than line BC, generation mullite (Al₆Si₂O₁₁) and crystallization of the specific component occur easily as a result of reaction between the amorphous glass component and alumina. When the added amount of the specific component is less than line CD, generation of mullite (Al₆Si₂O₁₃) occurs easily. When the added amounts of the amorphous glass component and the specific component are less than line AD, the ratio of alumina increases and sinterability becomes poor.

It is preferable to use high-purity alumina powder having an average particle size of 2 μm or less as the raw material. As a result of alumina being particle with an average particle size of 2 μm or less, the conduction path (grain-boundary path) formed in the grain boundary lengthens, and voltage endurance is improved. However, when the alumina particles are too fine, crystal particle growth becomes activated during the firing procedure. Therefore, the average particle size is preferably 0.5 μm. More preferably, an alumina powder having an average particle size of 0.4 μm to 1.0 μm is used. As the amorphous glass component and the specific component, ordinarily, raw material powders that are finer than the alumina powder should be used. For example, it is preferable to use high-purity micro-particle powders with an average particle size that is one-fifth of that of the alumina powder or less.

Furthermore, when the composition ratio of the amorphous glass component is within the specified range shown in FIG. 2E, crystallization is suppressed, and an amorphous grain boundary phase is easily formed. FIG. 2E is a triangular coordinate chart of which the peaks are SiO₂, CaO, and MgO when the composition ratio of SiO₂, CaO, and MgO that are the amorphous glass component is SiO₂:CaO:MgO=a′:b′:c′ (a′+b′+c′=100% by weight). Here, the amorphous glass composition is mixed such that a point (a′,b′,c′) is within a range surrounded by four points, A′(100,0,0), B′(75,25,0), C′(75,20,5), and D′(95,0,5) (however, point A′ is excluded). The triangular coordinates indicate a range in which SiO₂ is 50% to 100% by weight, CaO is 0% to 50% by weight, and MgO is 0% to 50% by weight.

As shown in FIG. 2B, a preferable composition ratio of the amorphous glass component is a range satisfying all of: 75% to 100% by weight of SiO₂ serving as an amorphous glass base material; 0% to 5% by weight of CaO serving as an impurity component; and 0% to 25% by weight of MgO also serving as an impurity component. When the amorphous glass component is combined with the specific component and the mixture is adjusted to the specified range shown in FIG. 2A, precipitation of crystalline components does not occur, and the effect of generating a uniform amorphous grain boundary glass phase is high.

As shown, in FIG. 1A, the alumina sintered body is manufactured by using alumina 11, the amorphous glass component 12, and the specific component 13 serving as the raw materials. First, the raw materials are weighed such as to form a predetermined mixture composition, described above (weighing procedure 20). The mixture composition is then dispersed in water to form a mixed slurry using a stirrer (mixing procedure 30). At this time, a dispersant or a binder may be used as required. Next, the resultant mixed slurry is dried by granulating spray drying and formed into granules (granulating procedure 40). The granules are molded into a predetermined shape, such as into the shape of the insulator of a spark plug (molding procedure 50), and fired at a temperature of 1500° C. or less (firing procedure 60). As a result, the alumina sintered body of the present invention is formed.

The alumina sintered body of the present invention has a low-melting-point amorphous grain boundary glass phase in the grain boundaries of the main phase made of alumina crystals, and promotes sintering of alumina at a low temperature. As a result of the specific component being mixed in the amorphous glass component, the energy band gap of amorphous grain boundary glass phase can be increased to, for example, 3.5 eV or more. This is described with reference to FIG. 1B. FIG. 1B shows the energy level structure of SiO₂, in which the energy band gap between a valance band 70 and a conduction band 80 is large. When the impurity components CaO and MgO are added therein to lower the melting point, an impurity level 90 is formed, and the energy band gap (ΔeV) between the impurity level 90 and the conduction band 80 becomes small. Therefore, excitation of electrons to the conduction band 80 when an electric field is applied occurs easily, causing voltage endurance to decrease. On the other hand, as a result of the specific component 13 being further added to the amorphous glass component 12, the impurity level 90 is eliminated. The number of electrons generated is reduced, and the insulation resistance value is assumed to increase as a result.

Therefore, voltage endurance can be improved while maintaining the amorphous glass structure. In other words, compared to a sintered body formed by grain-boundary crystallization as in the past, a compact sintered body can be achieved at a low firing temperature of 1500° C. or less, and the energy band gap can be increased by addition of the specific component 13. In addition, because the sintering temperature is low, at about 1450° C., the grain growth of the alumina crystals that are the main phase can be significantly suppressed, and the path for the current flowing through the grain-boundary surfaces when an electric field is applied can be lengthened. Therefore, voltage endurance can be made greater than 30 kV/mm, and more preferably 35 kV/mm or more.

### EXAMPLES

### Example 1

Alumina sintered bodies were manufactured based on the flowchart in FIG. 1A. Yttria (Y₂O₃) was used as the specific component. In the weighing procedure 20 in FIG. 1A, as raw material powders, alumina powder, silica powder serving as the amorphous glass component, magnesia powder and calcia powder serving as the impurity component, and yttria powder serving as the specific component were weighed to achieve mixing ratios of predetermined amounts indicated in Table 1A as samples 1 to 29. Specifically, as alumina powder, a fine powder with an average particle size of 0.5 μm and a purity of 99.9% or higher was used. As silica powder, magnesia powder, calcia powder, and yttria powder, fine powders with an average particle size of 0.1 μm and a purity of 95.9% or higher were used. The composition ratio of SiO₂ that was the amorphous glass component, and CaO and MgO that were the impurity component was SiO₂:CaO:MgO=86.9:10.2:2.9 (% by weight). For comparison, the specific component was not used in samples 1 to 4.

TABLE 1A

| | Weight (wt %) | | | | |
|---|---|---|---|---|---|
| | | Amount of amorphous | Specific | | Firing |
| Sample | Alumina | glass component | component | | temperature |
| 1 | 98 | 2.0 | None | | 1400 |
| 2 | | (SiO₂:MgO:CaO) = | | | 1450 |
| 3 | | (86.9:10.2:2.9) | | | 1500 |
| 4 | | | | | 1550 |
| 5 | | | Y₂O₃ | 1.0 | 1400 |
| 6 | | | | | 1450 |
| 7 | | | | | 1500 |
| 8 | | | | | 1550 |
| 9 | | | HfO₂ | 1.0 | 1400 |
| 10 | | | | | 1450 |
| 11 | | | | | 1500 |
| 12 | | | | | 1550 |
| 13 | | | ZrO₂ | 1.0 | 1400 |
| 14 | | | | | 1450 |
| 15 | | | | | 1500 |
| 16 | | | | | 1550 |

In the mixing procedure 30, to mix the raw material powders first, pure water and a dispersant were added into a mixing tank provided with a stirring blade. Next, the silica powder, the magnesia powder, the calcia powder, and the yttria powder were added. The mixture was then stirred and mixed, thereby forming a mixed slurry. The alumina powder was further added to the mixed slurry, mixed using a mixing and dispersing means, such as a high-speed rotor mixer, and uniformly dispersed.

In the granulating procedure 40, a granulating aid was added to the resultant mixed slurry, and the mixed slurry was granulated and dried by a known granulating method using a spray dryer, thereby forming a granular powder. In the molding procedure 50, the resultant granular powder was used to form a compact in a predetermined insulator shape by a known molding method.

In the firing procedure 60, the resultant compact was fired for one to three hours using a known furnace, in atmosphere. The firing temperature was within a range of 1400° C. to 1550° C. indicated in Table 1A. For each composition of samples 1 to 8, sinterability and voltage endurance of the resultant alumina sintered body was measured and included in Table 1B.

TABLE 1B

| | Voltage | | |
|---|---|---|---|
| | endurance | | |
| Sample | (kV/mm) | Sinterability | ΔeV |
| 1 | 15 | x | 3.0 |
| 2 | 24 | ∘ | |
| 3 | 28 | ∘ | |
| 4 | 30 | ∘ | |
| 5 | 24 | x | 4.2 |
| 6 | 36 | ∘ | |
| 7 | 34 | ∘ | |
| 8 | 30 | Δ | |
| 9 | 25 | x | 4.3 |
| 10 | 36 | ∘ | |
| 11 | 35 | ∘ | |
| 12 | 28 | Δ | |
| 13 | 22 | x | 4.1 |
| 14 | 34 | ∘ | |
| 15 | 32 | ∘ | |
| 16 | 27 | Δ | |

Here, sinterability was indicated as being “∘” when the density of the resultant alumina sintered body was 95% or more of a theoretical density, and “x” when the density was less than of the theoretical density. In addition, sinterability of alumina sintered bodies in which grain growth of the alumina crystals and precipitation of crystals within the amorphous grain boundary glass phase could be seen was indicated as being “Δ”. Voltage endurance was measured using a voltage endurance measuring device. Specifically, an internal electrode of the voltage endurance measuring device was inserted into the alumina sintered body having an insulator shape, and a circular ring-shaped outer electrode was fitted around the outer periphery of the alumina sintered body. Both electrodes were placed such that the thickness of a measuring point was constantly 1.0±0.05 mm. A high voltage generated by an oscillator and a coil from a constant voltage power supply was applied while monitoring by an oscilloscope, and applied voltage was incremented in steps, at a rate of 1 kV per second, at a frequency of 20 cycles per second. The voltage at which insulation breakdown occurred in the alumina sintered body was the voltage endurance of the alumina sintered body.

Furthermore, as shown in Table 1A, alumina sintered bodies in which hafnia (HfO₂) or zirconia (ZrO₂) was used in place of yttria (Y₂O₃) as the specific component were manufactured by a similar method as samples 9 to 12 and samples 13 to 16. The composition ratio of the alumina powder, the amorphous glass component, and the specific component was the same in all samples, and was 98% by weight of alumina, 2% by weight of the amorphous glass component, and 1% by weight of the specific component. The firing temperatures of these samples were also set within the range of 1400° C. to 1550° C., and sinterability and voltage endurance thereof were included in Table 1B.

As was clear from Table 1B, in samples 1 to 4 in which the specific component had not been added, favorable sinterability was achieved at a firing temperature of 1450° C. or higher, and low-temperature sintering was made possible as a result of the amorphous glass component. Although voltage endurance increased in accompaniment, voltage endurance was 24 kV/mm at 1450° C. and 30 kV/mm at 1550° C., and did not exceed 30 kV/mm. On the other hand, samples 5 to 8 in which the specific component (Y₂O₃) had been mixed in the amorphous glass component with the composition ratio of the present invention shown in FIG. 2, described above, indicated voltage endurance of 26 kV/mm at a firing temperature of 1450° C. and 24 kV/Trim at a firing temperature of 1500° C., and dielectric strength voltage was significantly improved. When the firing temperature exceeded 1450° C., voltage endurance tended to decrease, and at a firing temperature of 1550° C., voltage endurance became equivalent to that of sample 4 in which the specific component had not been added.

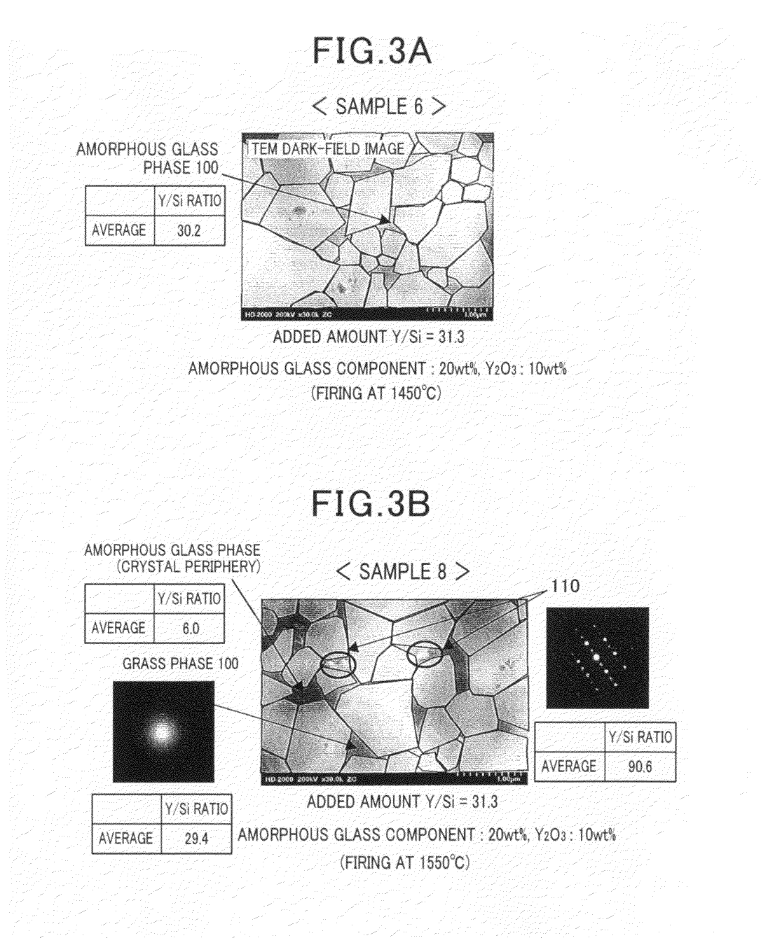

FIG. 3A and FIG. 3B respectively showed transmission electron microscopy (TEM) images of sample 6 (firing temperature of 1450° C.) and sample 8 (firing temperature of 1450° C.). In sample 6 in FIG. 3A, precipitation of crystals and the like could not be seen, and the Y/Si ratio (30.2) in the amorphous glass phase 100 was equivalent to the Y/Si ratio (31.3) based on the added amount. As a result, it was clear that the specific component had dissolved within the amorphous glass phase, the melting point of amorphous glass had decreased, and sinterability had been improved. After sintering, a uniform amorphous grain boundary glass phase was formed, the energy band gap widened from the effect of the specific component, and a high voltage endurance glass was formed. Furthermore, because the amorphous glass was present as amorphous glass, a weak structure, such as a defect or grain boundaries and the like, was not present, and insulation characteristics were further improved.

On the other hand, in sample 8 in FIG. 3B, precipitation of Y₂Si₂O₇ crystals 110 and the like could be seen within the amorphous glass phase 100, and because the specific component crystallized, the Y/Si ratio (90.6) of the vicinity became large. Conversely, in the periphery, the Y/Si ratio (6.0) became small in same areas. In this way, as a result of crystallization of the specific component, the grain boundaries and weak structures such as defects breakdown first, and insulation characteristics tended to deteriorate. Furthermore, in the periphery of crystallization, the specific component was absorbed. Therefore, the effect of increasing voltage endurance of the amorphous grain boundary glass phase by the specific component decreased, and therefore, breakdown occurred first.

Regarding samples 9 to 12 and samples 13 to 16 using hafnia (HfO₂) or zirconia (ZrO₂) as the specific component in Table 1A and 1B as well, tendencies similar to those of yttria (Y₂O₃) could be seen. In other words, as a result of the specific component (HfO₂ or ZrO₂) being mixed with the composition ratio of the present invention shown in FIG. 2A, described above, voltage endurances of sample 10 and sample 14 at a firing temperature of 1450° C. were respectively 38 kV/mm and 34 kV/mm, and voltage endurances of sample 11 and sample 15 at a firing temperature of 1550° C. were respectively 35 kV/mm and 32 kV/mm, and the dielectric strength voltage had significantly increased. Sinterability and voltage endurance characteristics of hafnia (HfO₂) or zirconia (ZrO₂) at firing temperatures of 1400° C. and 1550° C. also indicated tendencies similar to those of yttria (Y₂O₃).

Therefore, in the present invention, as a result of the amorphous grain boundary glass phase having the specified composition range shown in FIG. 2, low-temperature sintering in the vicinity of 1450° C. that had been difficult in the past became possible, and an amorphous, high-voltage-endurance glass could be formed. Increased voltage endurance as a result of the specific component was more effectively achieved as a result of the amorphous grain boundary glass phase being a uniform amorphous glass that did not include crystals and the like, and therefore, the firing temperature was 1500° C. and more preferably in the vicinity of 1450° C.

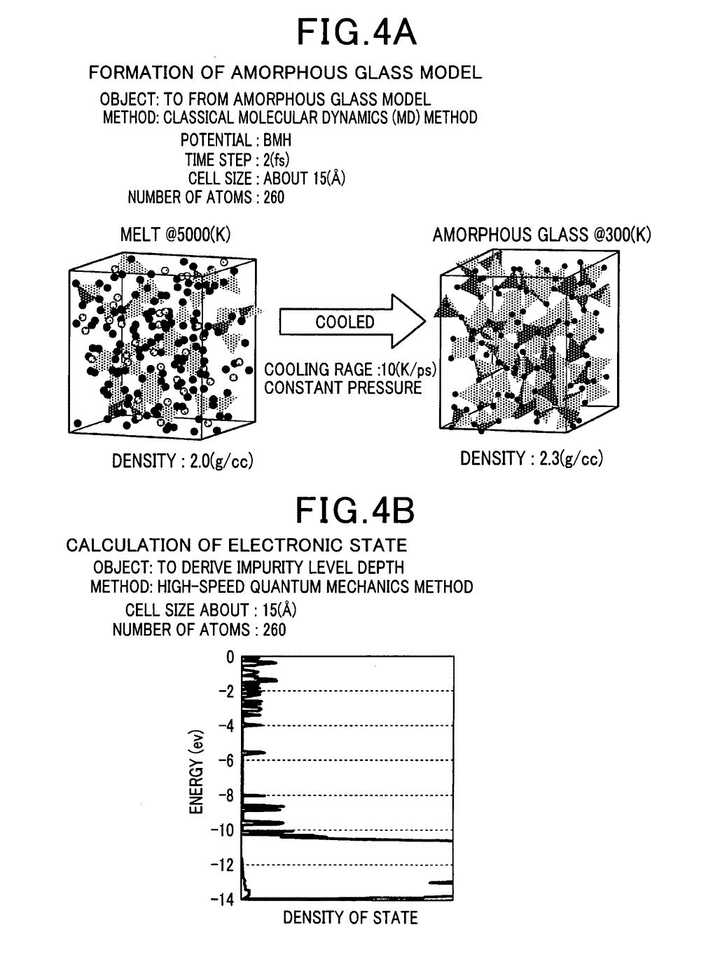

Furthermore, as a value indicating voltage endurance characteristics due to the specific component, the energy band gap (ΔeV) calculated using an amorphous glass model was included in Table 1B. An amorphous glass structure model shown in FIG. 4A was used to calculate the energy band gap (ΔeV). Through simulation using the classical molecular dynamics (MD) method, an amorphous glass structure was reproduced of an instance in which a melt (5,000K) in which the specific component had been added to the amorphous glass component (SiO₂, CaO, and MgO) was cooled to 300K at a predetermined cooling rate (10K/ps), under constant pressure. The conditions at this time were BMH potential and a time step of 2(fs). As shown in FIG. 4B, calculation of an electronic state based on high-speed quantum mechanics method was performed for the amorphous glass structure model. Impurity level depth was derived from the energy level and the density-of-state distribution, and the energy band gap (ΔeV) was calculated.

As was clear from Table 1E, the energy band gap (ΔeV) was 3.0 eV in the compositions of samples 1 to 4 that did not include the specific component, whereas the energy band gap (Δev) increased to 4.2 eV in the compositions of samples 5 to 8 in which the specific component (Y₂O₃) was mixed in the amorphous glass component. Furthermore, the energy band gap (ΔeV) was also wide, at 4.3 eV and 4.1 eV, in samples 9 to 12 and samples 13 to 16 in which the specific component had been changed, in close correlation with the measurement results of voltage endurance.

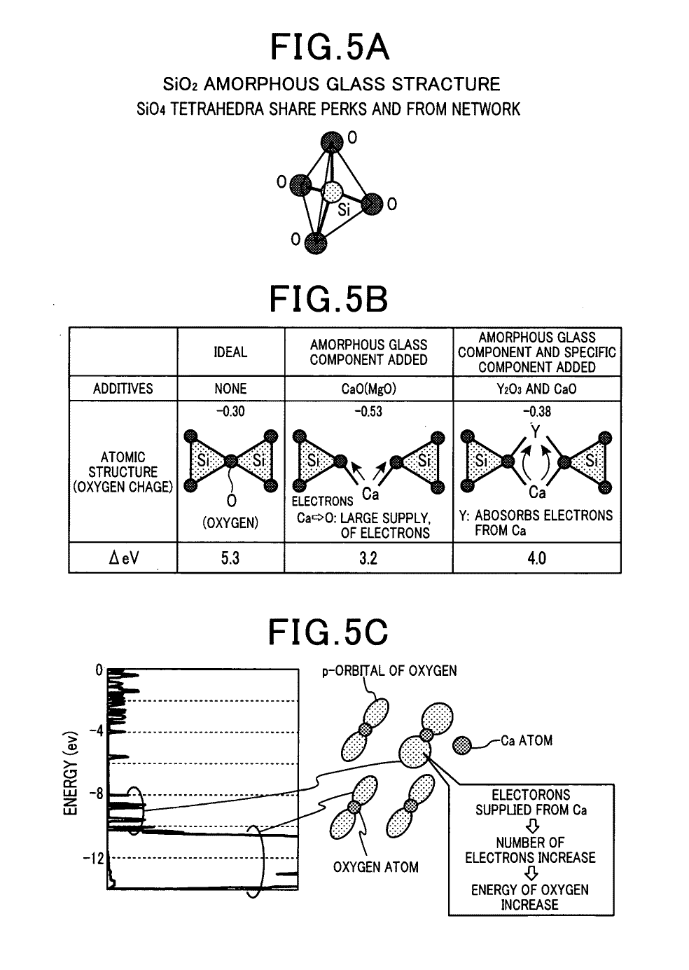

The correlation will be described with reference to FIG. 5A to FIG. 5C. As shown in FIG. 5A, it is known that, in a SiO₂ amorphous glass, SiO₄ tetrahedra share peaks, forming a mesh network structure. Although CaO and MgO added to the SiO₂ amorphous glass as the impurity component are captured in the mesh of the network and become amorphous, CaO and MgO are predisposed to supply oxygen atoms with electrons as shown in FIG. 5B. Therefore, as shown in FIG. 5C, the p-orbital energy of oxygen is thought to increase, thereby reducing the energy band gap (ΔeV) of SiO₂. The specific component of the present invention easily absorbs electrons because of space in the d-orbital. As a result of the specific component being mixed with CaO and MgO in the amorphous glass phase, an effect of suppressing the increase in orbital energy is achieved.

Table 2 showed the energy band gap (ΔeV) calculated using a similar method when the combinations of the amorphous glass component (SiO₂, CaO, and MgO) and the specific component were changed. As was clear from Table 2, the amorphous glass phase in which either one of CaO and MgO or both was added to SiO₂ has an energy band gap (ΔeV) of 3.0 eV to 3.4 eV. On the other hand, the amorphous grain boundary glass phase in which Y₂O₃, HfO₂, TiO₂, ZrO₂, and Sc₂O₃ were mixed as the specific component had a wider energy hand gap (ΔeV) of 4.0 eV to 4.3 eV. The impurity level formed by CaO and MgO was eliminated as a result of the specific component being added, or the formation of the impurity level was suppressed, contributing to the improvement in voltage endurance characteristics.

TABLE 2
Flow of oxygen charge and electrons

| | Band gap ΔeV | Note |
|---|---|---|
| SiO₂ + CaO | 3.2 | Ca impurity level formed |
| SiO₂ + MgO | 3.4 | Mg impurity level formed |
| SiO₂ + CaO + MgO | 3.0 | Impurity level formed |
| SiO₂ + CaO + Y₂O₃ | 4.0 | Ca impurity level eliminated |
| | | by addition |
| SiO₂ + MgO + Y₂O₃ | 4.1 | Mg impurity level eliminated |
| | | by addition |
| SiO₂ + CaO + MgO + Y₂O₃ | 4.2 | — |
| SiO₂ + CaO + MgO + HfO₂ | 4.3 | — |
| SiO₂ + CaO + MgO + TiO₂ | 4.0 | — |
| SiO₂ + CaO + MgO + ZrO₂ | 4.1 | — |
| SiO₂ + CaO + MgO + Sc₂O₃ | 4.3 | — |

### Example 2

Next, alumina sintered bodies (samples 17 to 45) were manufactured by a similar method, with the composition ratio of the alumina powder, the amorphous glass component, and the specific component changed as shown in Table 3A, when the specific component was yttria (Y₂O₃). The composition ratio of SiO₂ that was the amorphous glass component, and Cab and MgO that were the impurity component was SiO₂:CaO:MgO=86.9:10.2:2.9 (% by weight). The composition contained 98% by weight of the alumina powder, 2% by weight of the amorphous glass component, and 1% by weight of the specific component, and hafnia (HfO₂) and zirconia (ZrO₂) were used in addition to yttria (Y₂O₃) an the specific component. In addition, the sintering temperature was 1450° C.

TABLE 3A

| | Weight (wt %) | | |
|---|---|---|---|
| | | Amount of amorphous | |
| Sample | Alumina | glass component | Y₂O₃ |
| 17 | 99.0 | 1.0 | 0.0 |
| 18 | 98.5 | | 0.5 |
| 19 | 98.0 | | 1.0 |
| 20 | 97.5 | | 1.5 |
| 21 | 98.0 | | 2.0 |
| 22 | 98.0 | 2.0 | 0.0 |
| 23 | 97.8 | | 0.2 |
| 24 | 97.5 | | 0.5 |
| 25 | 97.0 | | 1.0 |
| 26 | 96.5 | | 1.5 |
| 27 | 96.0 | | 2.0 |
| 28 | 95.5 | | 2.5 |
| 29 | 95.0 | 5.0 | 0.0 |
| 30 | 94.5 | | 0.5 |
| 31 | 94.0 | | 1.0 |
| 32 | 93.5 | | 1.5 |
| 33 | 93.0 | | 2.0 |
| 34 | 92.0 | | 3.0 |
| 35 | 91.0 | | 4.0 |
| 36 | 90.0 | | 5.0 |
| 37 | 89.0 | | 6.0 |
| 38 | 94.0 | 6.0 | 0.0 |
| 39 | 93.0 | | 1.0 |
| 40 | 92.0 | | 2.0 |
| 41 | 91.0 | | 3.0 |
| 42 | 90.0 | | 4.0 |
| 43 | 89.0 | | 5.0 |
| 44 | 88.0 | | 6.0 |
| 45 | 87.0 | | 7.0 |

Sinterability was similarly examined for the resultant alumina sintered body, and the results were included in Table 3B. In a manner similar to that in the first example 1, sinterability was indicated as being “∘” when the density of the resultant alumina sintered body was 950 or more of a theoretical density, and “x” when the density was less than 95% of the theoretical density. In addition, sinterability of alumina sintered bodies in which crystals had precipitated within the amorphous grain boundary glass phase was indicated as being “Δ”. The results were included in Table 3B.

TABLE 3B

| Sample | Sinterabilty | Crystalline product |
|---|---|---|
| 17 | x | Amorphous glass |
| 18 | x | Amorphous glass |
| 19 | ∘ | Amorphous glass |
| 20 | Δ | Amorphous glass and Y₂O₃ |
| 21 | Δ | Amorphous glass, Y₂Si₂O₇, and Y₂O₃ |
| 22 | x | Amorphous glass |
| 23 | ∘ | Amorphous glass |
| 24 | ∘ | Amorphous glass |
| 25 | ∘ | Amorphous glass |
| 26 | ∘ | Amozphous glass |
| 27 | ∘ | Amorphous glass |
| 28 | Δ | Amorphous glass and Y₂O₃ |
| 29 | Δ | Amorphous glass and mullite |
| 30 | Δ | Amorphous glass and mullite |
| 31 | Δ | Amorphous glass and mullite |
| 32 | ∘ | Amorphous glass |
| 33 | ∘ | Amorphous glass |
| 34 | ∘ | Amorphous glass |
| 35 | ∘ | Amorphous glass |
| 36 | ∘ | Amorphous glass |
| 37 | Δ | Amorphous glass, mullite, and Y₂O₃ |
| 38 | Δ | Amorphous glass and mullite |
| 39 | Δ | Amorphous glass and mullite |
| 40 | Δ | Amorphous glass and mullite |
| 41 | Δ | Amorphous glass, mullite, and Y₂O₃ |
| 42 | Δ | Amorphous glass, mullite, and Y₂O₃ |
| 43 | Δ | Amorphous glass, mullite, and Y₂O₃ |
| 44 | Δ | Amorphous glass, mullite, and Y₂O₃ |
| 45 | Δ | Amorphous glass, mullite, and Y₂O₃ |

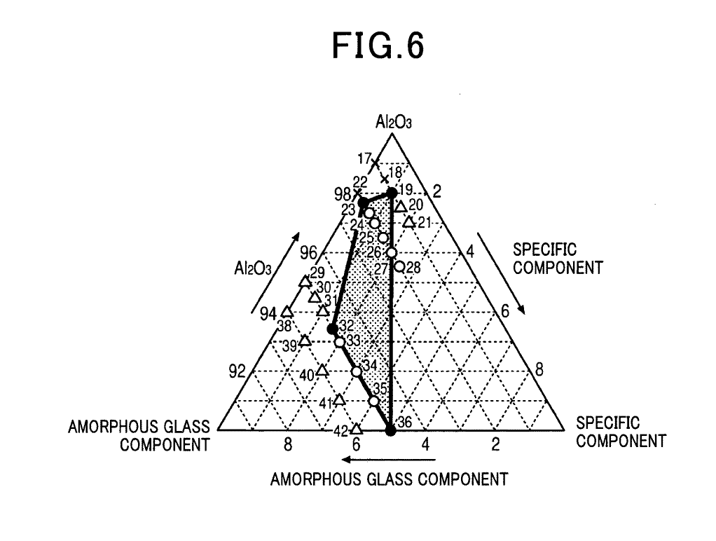

FIG. 6 showed the triangular coordinates shown in FIG. 2A, described above, in which the compositions and results of samples 17 to 45 in Table 3A and Table 3B were indicated with “∘” “Δ” and “x”. Samples 37, and 43 to 45 in which alumina was less than 90% by weight were omitted. Table 3A, 3B and FIG. 6 indicated that when the composition ratio of alumina, the amorphous glass component, and the specific component was within the range of the present invention, favorable sinterability was achieved, and a compact sintered body could be achieved at 1450° C. or below. When the composition ratio was outside of the range of the present invention, the sintered body was unsintered at 1450° C. or below, or precipitation of crystalline components, such as yttria crystals or mullite crystals, that was the specific component easily occurred.

In addition, when voltage endurance of the resultant alumina sintered bodies were measured, all samples 19, 23 to 27, and 32 to 36 (examples of the present invention) of which sinterability was “∘” had voltage endurance of 35 kV/mm or more. On the other hand, all samples 17, 18, 20 to 22, 28 to 31, and 37 to 45 (comparison examples) of which sinterability was “Δ” or “x” had voltage endurance of 30 kV/mm or less. Furthermore, when sinterability and voltage endurance of samples in which the composition of the amorphous glass component (SiO₂, CaO, MgO) had been changed within the range shown in FIG. 2B were examined by a similar method, in all samples, an amorphous glass phase was formed in the grain boundaries, and precipitation of crystals could not be seen. In addition, voltage endurance was 35 kV/mm or more and favorable voltage endurance was achieved.

As described above, the alumina sintered body of the present invention has excellent voltage endurance and low-costs related to the firing procedure. Therefore, the alumina sintered body is effective for use in insulating materials in spark plugs for combustion engines in automobiles, engine components, and integrated chip (IC) substrates. The preset invention, however, is not limited to these examples.

While there has been described what is at present considered to be these examples of the invention, it will be understood that various examples which are not described yet may be made therein, and it is intended to cover all claims within the true spirit and scope of the invention.

What is claimed is:

1. An alumina sintered body comprising alumina crystals as a main phase and an amorphous grain boundary phase formed in crystal grain boundaries of the alumina crystals, wherein
the amorphous grain boundary phase is an amorphous grain boundary glass phase having an amorphous glass component in which at least one of either CaO or MgO is added to SiO₂, and at least one type of oxide selected from rare-earth elements and elements in Group IV of the periodic table included in the amorphous glass component as a specific component; and
when a composition ratio of the main phase and the amorphous grain boundary glass phase is alumina:amorphous glass component:specific component=a:b:c (a+b+c=100% by weight), in a triangular coordinate of which peaks are alumina, the amorphous glass component, and the specific component, a point (a,b,c) is within a range surrounded by four points, A(98.0,1.0,1.0), D(90.0,5.0,5.0), C(93.5,5.0,1.5), and D(97.8,2.0,0.2).

2. The alumina sintered body according to claim 1, wherein a firing temperature is 1500° C. or below, and the amorphous grain boundary phase does not include a crystalline component that is a crystallization of the amorphous glass component or the specific component, or a crystalline component generated from reaction between the amorphous glass component, the specific component, and alumina.

3. The alumina sintered body according to claim 1, wherein when a composition ratio of the amorphous glass component in the amorphous grain boundary glass phase is SiO₂:CaO:MgO=a′:b′:c′ (a′+b′+c′=100% by weight), in a triangular coordinate of which peaks are SiO₂, CaO, and MgO, a point (a′,b′,c′) is within a range surrounded by four points, A′(100,0,0), B′(75,25,0), C′(75,20,5), and D′(95,0,5) (however, A′ is excluded).

4. The alumina sintered body according to claim 1, wherein the amorphous grain boundary glass phase has an energy band gap (ΔeV) of 3.5 eV or more.

5. The alumina sintered body according to claim 1, wherein the rare-earth elements include Y, Sc, and lanthanoid element, and the elements in Group IV of the periodic table include Hf, Zr, and Ti.

6. The alumina sintered body according to claim 1, wherein the specific component is at least one type of oxide selected from Y₂O₃, HfO₂, ZrO₂, Sc₂O₃, and TiO₂.

7. The alumina sintered body according to claim 1, wherein voltage endurance is greater than 30 kV/mm.

8. The alumina sintered body according to claim 2, wherein when a composition ratio of the amorphous glass component in the amorphous grain boundary glass phase is SiO₂:CaO:MgO=a′:b′:b′:c′ (a′+b′+c′=100% by weight), in a triangular coordinate of which peaks are SiO₂, CaO, and MgO, a point (a′,b′,c′) is within a range surrounded by four points, A′(100,0,0), B′(75,25,0), C′(75,20,5), and D′(95,0,5) (however, A′ is excluded).

9. The alumina sintered body according to claim 8, wherein the amorphous grain boundary glass phase has an energy band gap (ΔeV) of 3.5 eV or more.

10. The alumina sintered body according to claim 9, wherein the rare-earth elements include Y, Sc, and lanthanoid element, and the elements in Group IV of the periodic table include Hf, Zr, and Ti.

11. The alumina sintered body according to claim 10, wherein the specific component is at least one type of oxide selected from Y₂O₃, HfO₂, ZrO₂, Sc₂O₂, and TiO₂.

12. The alumina sintered body according to claim 3, wherein the amorphous grain boundary glass phase has an energy band gap (ΔeV) of 3.5 eV or more.

13. The alumina sintered body according to claim 12, wherein the rare-earth elements include Y, Sc, and lanthanoid element, and the elements in Group IV of the periodic table include Hf, Zr, and Ti.

14. The alumina sintered body according to claim 13, wherein the specific component is at least one type of oxide selected from Y₂O₃, HfO₂, ZrO₂, Sc₂O₃, and TiO₂.

15. The alumina sintered body according to claim 4, wherein the rare-earth elements include Y, Sc, and lanthanoid element, and the elements in Group IV of the periodic table include Hf, Zr, and Ti.

16. The alumina sintered body according to claim 15, wherein the specific component is at least one type of oxide selected from Y₂O₃, HfO₂, ZrO₂, Sc₂O₃, and TiO₂.

17. The alumina sintered body according to claim $, wherein the specific component is at least one type of oxide selected from Y₂O₃, HfO₂, ZrO₂, Sc₂O₃, and TiO₂.

18. The alumina sintered body according to claim 2, wherein voltage endurance is greater than 30 kV/mm.

19. The alumina sintered body according to claim 2, wherein voltage endurance is greater than 30 kV/mm.
